(19) United States
(12) Patent Application Publication
(10) Pub. No.: US 2026/0273556 A1
(43) Pub. Date: Sep. 17, 2026

(54) FLUID RESERVOIR FOR A PAINT SPRAY GUN WITH SCREW CAP AND SCREW CAP OR MATERIAL CONTAINER OF SUCH A FLUID RESERVOIR

(71) Applicant: SATA GmbH & Co. KG, Kornwestheim (DE)

(72) Inventor: Peter DETTLAFF, Remseck (DE)

(73) Assignee: SATA GmbH & Co. KG, Kornwestheim (DE)

(21) Appl. No.: 19/167,579

(22) PCT Filed: Feb. 7, 2024
(86) PCT No.: PCT/EP2024/053039

§ 371 Date: Sep. 22, 2025

(30) Foreign Application Priority Data
Mar. 23, 2023 (DE) 10 2023 107 368.0

(51) Int. Cl. B05B 7/24

(52) U.S. Cl. CPC B05B 7/241; B05B 7/2478

(57) ABSTRACT

A fluid reservoir for a paint spray gun has a material outlet which is designed for direct and/or indirect connection to a paint spray gun and a material container with a screw cap which closes the material container. When the material container and screw cap are connected in a releasable and fluid-tight manner, thereby forming a screw connection, an upper rim region of the material container is to be arranged in a receiving groove on the screw cap. The upper rim region of the material container has a projecting circumferential sealing element which is brought into planar sealing contact with a sealing surface of the screw cap.

### FIELD OF THE INVENTION

The invention relates to a fluid reservoir for a paint spray gun, said fluid reservoir having a material outlet which is designed for direct and/or indirect connection to a paint spray gun, wherein the fluid reservoir has a material container with a material container inner surface and a screw cap which closes the material container and has a fluid reservoir longitudinal axis, wherein, when the material container and screw cap are connected in a releasable and fluid-tight manner thereby forming a screw connection, an upper rim region of the material container is to be arranged in a receiving groove on the screw cap.

The invention further relates to a screw cap or to a material container of such a fluid reservoir.

### BACKGROUND

A fluid reservoir according to the design mentioned above is disclosed, for example, in DE102020120226 A1. The reservoir described therein has a material container and a cap with which the material container can be closed. To use the reservoir with a paint spray gun, the material container is first filled with a coating material to be applied. The material container filled with the coating material is then closed by means of the cap. To do this, the cap is placed on the material container, wherein the upper rim of the material container is inserted into a receiving groove in the cap. The fluid reservoir known from DE 102020120226 A1 is a reservoir with a screw cap, i.e. the cap is mounted on the material container by a rotary movement. A screw connection holds the cap on the material container, wherein a fluid-tight connection between the material container and the cap is created after screwing.

The fluid reservoir has a material outlet. In the case of DE102020120226 A1, the material outlet is provided on the cap. It is a so-called upside-down fluid reservoir, which is mounted on the paint spray gun with the cap facing downwards. Due to the effect of gravity, the coating material can flow from the material container into the paint spray gun via the material outlet on the cap. In compressed air atomizing paint spray guns, the coating material is additionally sucked out of the reservoir to the nozzle by a negative pressure generated at the atomizing nozzle.

In this context, it is also advantageous that the cap is designed as a screw cap, since a screw connection, unlike a snap-on connection, for example, is characterized by a high degree of robustness against transverse forces due to impacts or very fast pivoting movements. In addition, mounting or removing a snap-on cap entails vibrations of the cap and material container, which in turn increases the risk of uncontrolled, sudden detachment of paint residues from the surface of the cap or material container and splashing associated therewith. A screw cap, on the other hand, can be repeatedly mounted and removed smoothly and without vibration.

### SUMMARY OF THE INVENTION

An object of the present invention is to improve screw behavior between the screw cap and the material container.

A fluid reservoir and embodiments thereof are disclosed herein.

The fluid reservoir according to the invention for a paint spray gun has a material outlet which is designed for direct and/or indirect connection to a paint spray gun, wherein the fluid reservoir has a material container with a screw cap which closes the material container and has a fluid reservoir longitudinal axis, wherein, when the material container and screw cap are connected in a releasable and fluid-tight manner thereby forming a screw connection, an upper rim region of the material container is to be arranged in a receiving groove on the screw cap. The fluid reservoir according to the invention is characterized in that a circumferential sealing element is provided which projects with respect to the upper rim region of the material container and which is brought into planar sealing contact with a sealing surface of the screw cap.

It is known from the prior art that sealing elements are provided on the screw cap, which form one or more narrow circumferential sealing lines between the screw cap and the material container. It is known that the sealing effect deteriorates when the sealing surface between two materials that are difficult to deform is increased, for which reason the person skilled in the art uses sealing elements with a narrow sealing line as standard in such cases.

It has been shown that in various material pairings negative effects occur between the screw cap and the material container when sealing elements with a narrow sealing line known from the prior art are used. This is why such material pairings have had to be avoided until now, even though they were advantageous for other reasons. Because the sealing element according to the invention is designed to form a planar contact between the screw cap and the material container, such negative side effects of unsuitable material pairings can be avoided. For example, so-called stick-slip effects that occur with different material pairings can be prevented and/or increased friction between the screw cap and the material container can be prevented, as may be the case, for example, if both parts are made of polypropylene.

A fluid reservoir according to the invention for a paint spray gun can be designed as a conventional fluid reservoir which carries the material outlet on the bottom side of the material container and is closed on its upper side with the screw cap. Such a conventional fluid reservoir is filled with material to be atomized when the fluid reservoir is mounted on the paint spray gun. Alternatively, the fluid reservoir can be designed as a so-called upside-down fluid reservoir, which carries its material outlet on the screw cap and preferably an air valve for air equalization on the opposite reservoir bottom. Such upside-down fluid reservoirs are placed for filling on a base with the bottom side of the material container, after which the material container is filled and the screw cap is mounted. The paint spray gun is then turned around with its reservoir connection on the top side such that the reservoir connection points downward, after which the paint spray gun is connected to the reservoir connection of the screw cap. The paint spray gun with the mounted fluid reservoir is then turned around so that the upside-down fluid reservoir is on the upper side of the paint spray gun.

Preferably, the sealing element projects from a material container inner surface and is brought into planar sealing contact at an outwardly facing sealing surface of the screw cap. Because the sealing element is provided on the material container inner surface, the screw cap is spread open when mounted on the material container, which results in a functionally reliable seal between the screw cap and the material container, which seals reliably even in the event of overpressure occurring in the fluid reservoir. Furthermore, an injection-molded part can be forcibly demolded particularly easily with a seal placed in this manner.

In case of a particularly preferred exemplary embodiment, the circumferential sealing element has a sealing element width which runs in the direction of the fluid reservoir longitudinal axis and along the material container inner surface. The sealing element further has a sealing element height in which the sealing element projects from the material container inner surface in the radial direction to the fluid reservoir longitudinal axis. The sealing element width is greater than the sealing element height. Particularly preferably, the sealing element width is at least ⅓ greater than the sealing element height, in particular the sealing element width is at least twice the sealing element height. The sealing element width is smaller than the length of a sealing element offset by which the sealing element is offset from the end face of the upper rim region of the material container. By appropriate dimensioning, a particularly rigid geometry of the sealing element can be created, which leads to easier demolding and lower manufacturing tolerances in the sealing region. This improves the sealing situation between the material container and the screw cap, as fewer unwanted deformations of the sealing element occur during forced demolding, which would adversely affect the sealing behavior.

Insofar as reference is made to the sealing element height, the sealing element height is to be understood to mean the extension of the sealing element in the radial direction to the fluid reservoir longitudinal axis away from the material container inner surface up to the point at which the outer surface is at a maximum distance from the adjacent material container inner surface in the radial direction to the fluid reservoir longitudinal axis. Insofar as reference is made to the sealing element width, the sealing element width is to be understood to mean the width of the sealing element at the base of the sealing element. This is hence the length extension across which the sealing element extends in the direction of the fluid reservoir longitudinal axis along the material container inner surface, wherein the beginning and end of the sealing element are formed by the transition between the material container inner surface and the flanks of the sealing element which are inclined relative thereto. In this region, the sealing element extends over its maximum length in the direction of the fluid reservoir longitudinal axis.

It is particularly advantageous if the sealing element has a contact region at which the sealing element abuts the sealing surface of the screw cap. The width of the contact region in the direction of the fluid reservoir longitudinal axis is greater than the sealing element height. In particular, the width of the contact region is more than 1.5 times greater than the sealing element height. Such a ratio between the width of the contact region and the sealing element height results in an enlarged contact region compared to a conventional sealing element while at the same time ensuring high stability of the sealing element in the direction of the fluid reservoir longitudinal axis. This improves the sliding properties and the sealing effect between the screw cap and the material container. Due to the improved sliding properties, the screw cap can be screwed onto the material container with significantly less force than is the case with conventional fluid reservoirs, which have a particularly small contact region between the screw cap and the material container.

Insofar as reference is made to the contact region, the contact region is understood to mean the region in which the sealing element abuts the opposite sealing surface of the screw cap when the screw cap is screwed onto the material container in a fluid-tight manner. The contact region can be designed to be either flat or curved in such a way that only the elasticity of the materials used creates a correspondingly large contact surface between the sealing element or contact region of the sealing element and the sealing surface of the screw cap. The width of the contact region in the direction of the fluid reservoir longitudinal axis is the extent of the contact region in said direction in which the sealing element of the material container and the sealing surface of the screw cap actually touch one another.

Advantageously, the sealing element has a contact region where the sealing element abuts the screw cap, which is designed to be so flat that the width of the contact region in the direction of the fluid reservoir longitudinal axis, in which the sealing element is brought into contact with the sealing surface when the material container and screw cap are connected in a fluid-tight manner, is greater than ⅓ of the sealing element width in the direction of the fluid reservoir longitudinal axis. Particularly preferably, the width of the contact region is smaller than the sealing element width, in particular smaller than half the sealing element width. Such a length ratio between the contact region and the sealing element width results in a particularly large contact surface in relation to the sealing element width, wherein the flanks of the sealing element, which extend between the contact region and the material container inner surface, have a particularly advantageous bevel which can be easily demolded.

Preferably, the angle of inclination of the tangent of a sealing element outer surface facing the fluid reservoir longitudinal axis is less than 15°, in particular less than 7°, across the sealing element width relative to the material container inner surface in a region of at least ⅓, in particular at least ½, of the sealing element width. Here, the sealing element outer surface in the direction of the fluid reservoir longitudinal axis can extend across a larger region than the contact region. In this case, the sealing element outer surface can, for example, have a convex curvature which in the central region relative to the fluid reservoir longitudinal axis has a larger radius of curvature than in the outer regions of the sealing element outer surface. In a further embodiment, the sealing element outer surface in the central region can also be designed in the form of a flat plane and can be designed substantially parallel to the material container inner surface in the direction of the fluid reservoir longitudinal axis. In this embodiment, the outer regions can be designed to be either convex or concave, or also in the form of a flat plane that connects the contact region with the material container inner surface. Such a design also results in an enlarged contact surface between the sealing element and the sealing surface of the screw cap and thus also to better sliding behavior between the material container and the screw cap. Preferably, the region in which the angle of inclination is less than 15° or less than 7° is located in the central region of the sealing element relative to the fluid reservoir longitudinal axis, which outer regions with a different angle of inclination adjoin on both sides.

Insofar as reference is made to the angle of inclination of the tangent relative to the fluid reservoir longitudinal axis, this is to be understood to mean the acute angle between the material container inner surface and a tangent lying in the same plane as the fluid reservoir longitudinal axis, wherein the tangent is applied in the manner of a curve discussion to the sealing element outer surface over the course of the sealing element outer surface in the direction of the fluid reservoir longitudinal axis and thus changes over the course of the sealing element outer surface in the direction of the fluid reservoir longitudinal axis, since the sealing element projects from the material container inner surface as intended. If a region of the sealing element outer surface is designed parallel to the material container inner surface viewed in the direction of the fluid reservoir longitudinal axis, the angle of inclination in this region will be 0° and only changes at the transition to the outer regions if these are designed in the form of a flat surface, or within the outer regions if they are concave or convex.

In a particularly preferred embodiment, the sealing element outer surface has a contact region, a sealing element upper flank connected to the contact region in the direction of the material outlet and a sealing element lower flank connected to the contact region in the opposite direction. Here, the angle of inclination of the tangent of the sealing element lower flank over its course in the direction of the fluid reservoir longitudinal axis is smaller than the angle of inclination of the sealing element upper flank. The sealing element lower flank and the sealing element upper flank form the previously described outer regions of the sealing element outer surface. Particularly preferably, the sealing element upper flank in the direction of the fluid reservoir longitudinal axis is smaller than the length of the sealing element lower flank. Such a design allows the sealing element to be forcibly demolded particularly easily due to the smaller inclination of the sealing element lower flank.

Preferably, the material container is formed in the upper rim region by a foldback, which has a foldback inner leg located on the inside in the radial direction to the fluid reservoir longitudinal axis and a foldback outer leg located outside in the radial direction to the fluid reservoir longitudinal axis. Here, the foldback inner leg and foldback outer leg are connected to one another at the front face of the upper rim region via a connecting web running in the radial direction, wherein the opposite side of the hemming is open. Preferably, the foldback inner leg and foldback outer leg are connected to one another along their circumference several times by stiffening ribs which run radially relative to the fluid reservoir longitudinal axis and which extend from the connecting web against the upper rim region of the material container. The stiffening ribs can be connected to the foldback inner leg or the foldback outer leg over a different length in the direction of the fluid reservoir longitudinal axis. Accordingly, the stiffening ribs bottom side of the stiffening ribs which faces opposite the screw cap is formed obliquely to the radial direction of the fluid reservoir longitudinal axis, preferably at an angle greater than 45° obliquely to the radial direction. With such a design, the upper rim region of the material container is stabilized, while the foldback inner leg and foldback outer leg remain decoupled from one another in such a way that both can move independently of one another.

It is particularly advantageous if in the direction of the fluid reservoir longitudinal axis the stiffening ribs are connected over a shorter length to the foldback inner leg than to the foldback outer leg. It is particularly advantageous if the stiffening ribs on the foldback inner leg end before the region in which the sealing element is provided on the material container inner surface, thus forming a stiffening rib clearance. The stiffening ribs thus extend from the connecting web in the direction of the sealing element on the inner side of the foldback inner leg facing the foldback outer leg, wherein the stiffening ribs end in front of the region in which the sealing element is located on the outer side of the foldback inner leg as seen in the radial direction and thus on the material container inner surface. In practice, it has been shown that injection-molding-related deformations occur in the region of the sealing element if the stiffening ribs extend into this region. Such injection-molding-related deformations can result in the sealing element does not fully abut the sealing surface of the screw cap. Such stiffening rib clearance can prevent such injection-molding-related deformations, which improves the sealing situation.

Advantageously, on the inner side of the foldback outer leg facing the foldback inner leg, the stiffening ribs extend, when viewed in the radial direction, into the region where the material container external thread is provided on the outer side of the foldback outer leg. This ensures that the sealing element is not negatively influenced by the injection molding process, while still ensuring that the forces acting on the thread during the screw process can be optimally dissipated. Due to the described design, the upper rim region of the material container can still be maximally reinforced with regard to the screwing process, even with a minimum wall thickness of the material, without the sealing element and thus the sealing situation being adversely influenced by the injection-molding process.

It is particularly advantageous if the stiffening ribs in the upper rim region of the material container are distributed at a uniform distance from one another around the circumference. Preferably, at least 8 and a maximum of 25 stiffening ribs are provided, which are evenly distributed around the circumference. In a particularly preferred embodiment, at least 10 and a maximum of 16 evenly distributed stiffening ribs are provided. Particularly preferably, 12 evenly distributed stiffening ribs are provided.

In a further embodiment, the sealing element has a substantially trapezoidal cross-section. In particular, the sealing element has the cross-section of a non-isosceles trapezoid. The shorter base side of the trapezoid forms the contact region of the sealing element. Such a design of the sealing element is easy to demold and, due to its flat contact region, offers particularly good sliding properties between the sealing element of the material container and the sealing surface of the screw cap, whereby less force is required to connect the screw cap to the material container in a fluid-tight manner.

Preferably, on its side located inside relative to the fluid reservoir longitudinal axis, the receiving groove on the screw cap is formed by an inner leg extending opposite to the material outlet and in the direction of the fluid reservoir longitudinal axis. This inner leg has the sealing surface on its outer side facing opposite to the fluid reservoir longitudinal axis. Here, the sealing element is offset from the front face of the upper rim region of the material container in the form of a sealing element offset across at least half, in particular across more than 60%, of the inner leg length with which the inner leg extends in the direction of the fluid reservoir longitudinal axis. This offset of the sealing element relative to the front face of the upper rim region ensures that the sealing element is not brought into contact with the sealing surface of the screw cap until the cap is almost completely screwed onto the material container. The sealing element thus affects the mounting of the screw cap only over a short distance, which reduces the force required when mounting the screw cap.

Preferably, the material container inner surface and the inner leg outer side have a flat guide region running in the direction of the fluid reservoir longitudinal axis, which extends from the sealing element or a contact surface of the sealing element on the screw cap in the direction of the fluid reservoir longitudinal axis and toward the material outlet, at least over the length in which the sealing element is offset from the front face of the upper rim region of the material container. Such guide region enables precise centering between the material container and the screw cap before the sealing element is brought into contact with the sealing surface during mounting of the screw cap.

In a preferred embodiment, when the material container and screw cap are connected in a fluid-tight manner, the inner circumference of the sealing element in the contact region and the outer circumference of the sealing surface in the region of the contact surface are designed such that the end face of the upper rim region and the groove base of the receiving groove are spaced apart from one another in the direction of the fluid reservoir longitudinal axis in such a way that a clearance is formed between the end face of the upper rim region and the groove base. The screw cap and the material container are correspondingly designed such that the end face of the upper rim region does not abut the groove base but rather a distance is provided between the groove base and the end face of the upper rim region even in the mounted state. Such clearance can be used to compensate for manufacturing tolerances, since the upper rim region does not abut the groove base, which would mean that no fluid-tight connection could be created between the screw cap and the material container if the inner circumference of the sealing element was too large in the contact region due to manufacturing tolerances or if the screw cap in the region of the outer circumference of the sealing surface was manufactured too small in the region of the contact surface. The clearance thus ensures a fluid-tight connection between the material container and the screw cap.

Preferably, the contact surface which the sealing element abuts in the case of a fluid-tight connection between the screw cap and the material container is provided in the region of one end of the inner leg of the receiving groove which faces away from the material outlet. This design makes it easier to mount the screw cap, as the sealing element engages with the material container only shortly before the screw cap is fully mounted and therefore does not affect the previous screwing path.

In a preferred embodiment, a circumferential stiffening ring extending substantially radially inwardly relative to the fluid reservoir longitudinal axis adjoins the end of the inner leg, which stiffening ring supports the end of the inner leg against a force directed toward the fluid reservoir longitudinal axis. Such stiffening ring can reduce the elasticity of the screw cap in the region of the contact surface, thus ensuring a fluid-tight connection between the screw cap and the material container.

Preferably, the material container has outwardly directed fastening means in the upper rim region, in particular in the form of a material container external thread, and the screw cap has inwardly directed counter-fastening means, in particular in the form of a screw cap internal thread. Such fastening means can ensure a functionally reliable attachment of the screw cap to the material container.

In a particularly preferred exemplary embodiment, the sealing element, the material container and the material container external thread as well as the screw cap and the screw cap internal thread are each designed as a one-piece injection-molded part. This design reduces the number of parts required, thereby saving manufacturing costs.

Preferably, the material container and the screw cap are injection-molded from polypropylene, or the material container from polypropylene (PP) and the screw cap from high-density polyethylene (HDPE). If both the material container and the screw cap are made of polypropylene, both parts can be designed to be particularly transparent, which makes it possible to clearly see the contents of the fluid reservoir or its fill level from the outside. If the material container is made of polypropylene and the screw cap is made of high-density polyethylene, an advantageous material pairing can be created between the screw cap and the material container, since the friction between the screw cap and the material container can be kept particularly low with this material pairing.

The invention is further realized by a screw cap or a material container designed for use as part of a fluid reservoir having the features described above and below.

Both the features described above and the features described below, including those from different embodiments, can be combined with one another, which can result in synergistic interactions that go beyond the sum of the individual effects. Furthermore, the different designs are also regarded as inventions in their own right, even if this is not explicitly mentioned. This also applies to the combination of different features of the individual designs with one another.

### BRIEF DESCRIPTION OF THE DRAWINGS

The invention is explained below with reference to various exemplary embodiments. The figures show:

FIG. 1 a sectional view of a paint spray gun with a fluid reservoir according to a first exemplary embodiment,

FIG. 2 a sectional view of a fluid reservoir according to a second exemplary embodiment,

FIG. 3 a sectional view of a screw cap for a fluid reservoir according to the second exemplary embodiment in FIG. 2,

FIG. 4 a perspective view of a material container for a fluid reservoir according to the second exemplary embodiment in FIG. 2,

FIG. 5 a detailed view of the screw cap according to the second exemplary embodiment in FIG. 2, which shows the region marked as B in FIG. 3,

FIG. 6 a detailed view of the fluid reservoir according to the second exemplary embodiment in FIG. 2, which shows the region marked as A in FIG. 2,

FIG. 7 a detailed view of the fluid reservoir according to the second exemplary embodiment in FIG. 2, which shows the region marked as A in FIG. 2 in an alternative embodiment,

FIG. 8 a detailed view of the material container according to the alternative embodiment of the paint reservoir in FIG. 2 shown in FIG. 7 in the region of the sealing element without a screw cap,

FIG. 9 a detailed view of the material container according to the alternative embodiment of the paint reservoir in FIG. 2 shown in FIG. 7 in the region of the sealing element,

FIG. 10 a detailed view of the material container according to the alternative embodiment of the paint reservoir in FIG. 2 shown in FIG. 7 in the region of the sealing element,

FIG. 11 a detailed view of the material container according to the alternative embodiment of the paint reservoir in FIG. 2 shown in FIG. 7 in the region of the sealing element according to an alternative embodiment of the sealing element, and

FIG. 12 a detailed view of the fluid reservoir according to the second exemplary embodiment in FIG. 2, which shows the region marked as A in FIG. 2 in an alternative embodiment.

### DETAILED DESCRIPTION

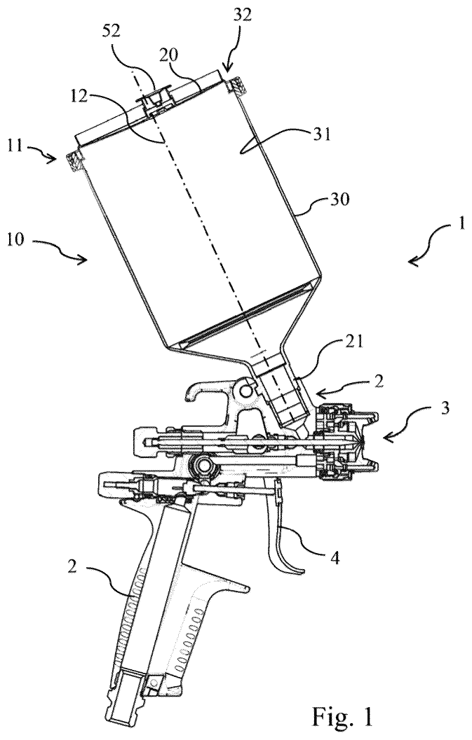

FIG. 1 shows a hand-held paint spray gun 1 for compressed air-assisted atomization and application of a flowable coating material. The paint spray gun 1 can be designed, for example, as a so-called high-pressure, compliant or HVLP spray gun 1. The paint spray gun 1 has a reservoir connection 2 and a nozzle head 3, at which coating material supplied via the reservoir connection 2 of the paint spray gun 1 is atomized and ejected in the form of a spray jet. Furthermore, a trigger 4 for actuating the paint spray gun 1 or for controlling the amount of coating material ejected from the nozzle head 3, as well as a handle 5 by which the paint spray gun 1 is held by the user, are provided.

FIG. 1 also shows a fluid reservoir 10 for a paint spray gun 1 having a material outlet 21 which is designed for direct and/or indirect connection to the paint spray gun 1. The fluid reservoir 10 has a material container 30 with a material container inner surface 31 and a screw cap 20 closing the material container 30. Also shown is a fluid reservoir longitudinal axis 12 of the fluid reservoir 10. A screw connection 11 is provided in the upper rim region 32 of the material container 30 for releasable and fluid-tight connection of the material container 30 and the screw cap 20, wherein the material container 30 is arranged in a receiving groove 22 on the screw cap 20 which on its outer side has a screw cap internal thread 29 shown in more detail in the following figures. The fluid reservoir 10 shown is a conventional fluid reservoir 10 in which the material outlet 21 is provided directly on the material container 30, wherein the screw cap 20 has a cap valve 52 for pressure equalization.

A circumferential sealing element 33 shown in more detail in the following figures is provided on the material container inner surface 31 which projects relative to the material container inner surface 31 and is brought into planar sealing contact with an outwardly facing sealing surface 23 of the screw cap 20.

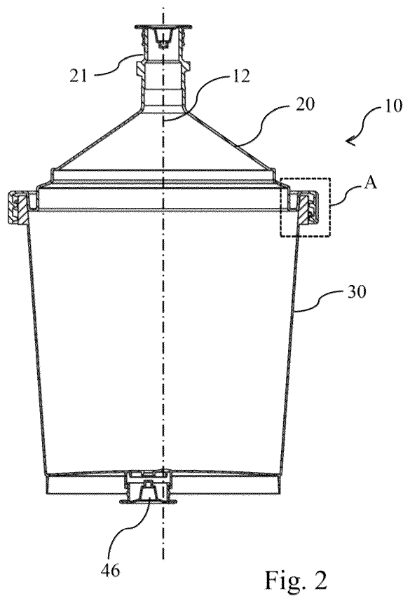

FIG. 2 shows a further embodiment of a fluid reservoir 10 according to the invention, wherein said fluid reservoir 10 is an upside-down fluid reservoir which has its material outlet 21 on the screw cap 20 and a bottom valve 46 is provided on the bottom side of the material container 30. Furthermore, a section A is shown, which is shown enlarged in FIG. 6.

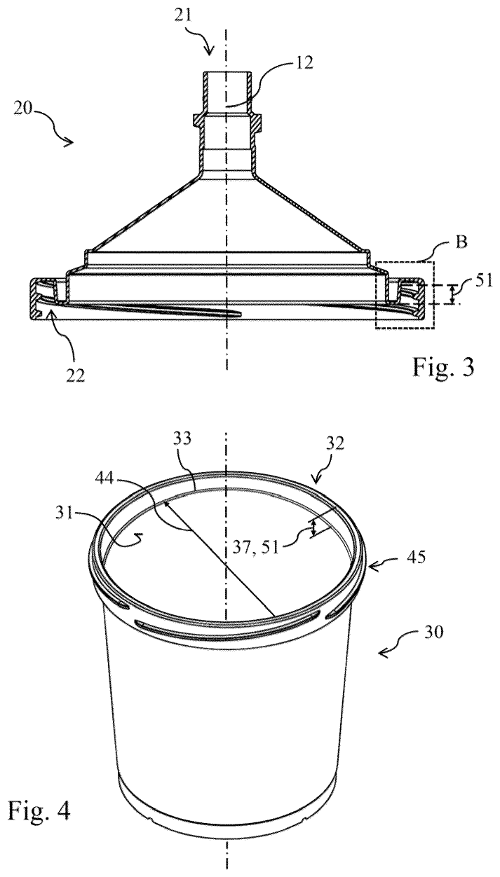

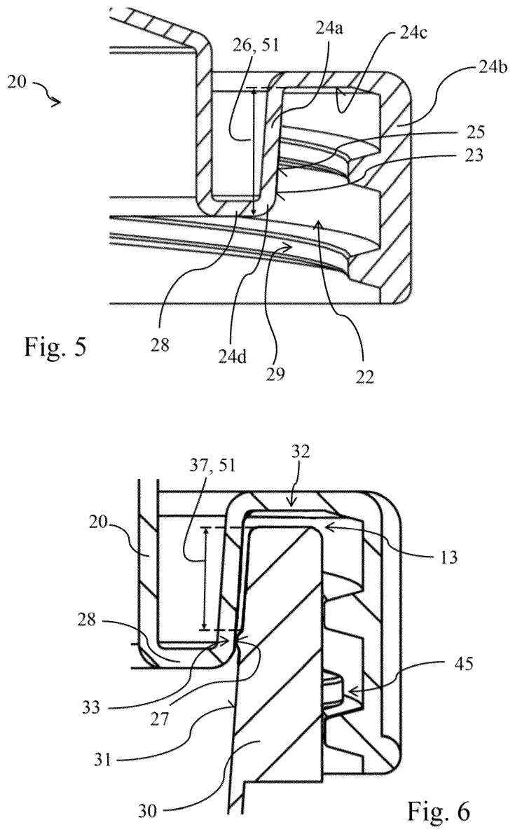

FIG. 3 shows a screw cap 20 of a fluid reservoir 10 as shown in FIG. 2. Furthermore, a section B is shown, which is shown enlarged in FIG. 6. Furthermore, a guide region 51 is shown which runs in the direction of the fluid reservoir longitudinal axis 12 and is located on the inner leg outer side 25 of the receiving groove 22, shown enlarged in FIG. 5. In the guide region 51, the inner leg outer side 25 is designed to be flat, wherein the guide region 51 extends from a contact surface 27 of the sealing element 33, which the sealing element 33 of the material container 30 abuts, in the direction of the fluid reservoir longitudinal axis 12 and toward the material outlet 21 over the length in which the sealing element 33 is offset from the front face of the upper rim region 32 of the material container 30. The length of the guide region 51 at the material container inner surface 31 in the direction of the fluid reservoir longitudinal axis 12 is between 2 mm and 10 mm, in particular between 3 mm and 4 mm.

FIG. 4 shows a material container 30 of the fluid reservoir 10 shown in FIG. 2. The material container 30 bears on its inner surface 31 the sealing element 33, which is offset from the front face of the upper rim region 32 of the material container 30 in such a way that a flat guide region 51 running in the direction of the fluid reservoir longitudinal axis 12 is formed, which extends from the sealing element 33 in the direction of the fluid reservoir longitudinal axis 12 and toward the end face of the upper rim region 32 over the length in which the sealing element 33 is offset from the end face of the upper rim region 32. In the contact region 38, in which the sealing element 33 is brought into contact with the sealing surface 23 of the screw cap 20, the inner circumference 44 of the sealing element 33 is designed such that the end face of the upper rim region 32 and the groove base 24c of the receiving groove 22 are spaced apart from one another in the direction of the fluid reservoir longitudinal axis 12 when the material container 30 and the screw cap 20 are connected in a fluid-tight manner in such a way that a clearance 13 shown in FIG. 6 is formed between the end face of the upper rim region 32 and the groove base 24c in order to compensate for manufacturing tolerances.

FIGS. 5 and 6 show the enlarged details marked as A and B in FIGS. 2 and 3. On its inner side relative to the fluid reservoir longitudinal axis 12 shown in the previous figures, the receiving groove 22 on the screw cap 20 is formed by an inner leg 24a extending opposite to the material outlet 21 and in the direction of the fluid reservoir longitudinal axis 12, on the inner leg outer side 25 facing opposite the fluid reservoir longitudinal axis 12 of which the sealing surface 23 is provided. Here, the sealing element 33 shown in FIG. 6 is offset from the end face of the upper rim region 32 of the material container 30 in the form of a sealing element offset 37 over at least half, and in the case shown over more than 60%, of the inner leg length 26 with which the inner leg 24a extends in the direction of the fluid reservoir longitudinal axis 12. The inner leg length 26 in the direction of the fluid reservoir longitudinal axis 12 is between 3 mm and 10 mm, in particular between 5 mm and 7 mm. The sealing element offset 37 forms a guide region 51 which centers the screw cap 20 and the material container 30 relative to one another before the sealing element 33 comes into contact with the sealing surface 23 when the screw cap 20 is mounted. The sealing element offset 37 relative to the front face of the upper rim region 32 of the material container 30 is between 2 mm and 7 mm, in particular between 3 mm and 5 mm, in the direction of the fluid reservoir longitudinal axis 12. In the radial direction to the fluid reservoir longitudinal axis 12, the outer leg 24b sits opposite the inner leg 24a, wherein the inner leg 24a and the outer leg 24b are connected to one another via the annular groove base 24c running in the radial direction to the fluid reservoir longitudinal axis 12.

Both the material container inner surface 31 and the inner leg outer side 25 have a flat guide region 51 running in the direction of the fluid reservoir longitudinal axis 12, which extends from the sealing element 33 or the contact surface 27 of the sealing element 33 on the screw cap 20 in the direction of the fluid reservoir longitudinal axis 12 and toward the material outlet 21, at least over the length in which the sealing element 33 is offset from the front face of the upper rim region 32 of the material container 30.

As can be seen in FIGS. 5 and 6, the inner circumference 44 of the sealing element 33 shown in FIG. 4 and the outer circumference of the sealing surface 23 in the region of the contact surface 27 are designed such that the end face of the upper rim region 32 and the groove base 24c of the receiving groove 22 are spaced apart from one another in the direction of the fluid reservoir longitudinal axis 12 such that in the state shown in FIG. 6, in which the material container 30 and screw cap 20 are connected to one another in a fluid-tight manner, a clearance 13 is formed between the end face of the upper rim region 32 and the groove base 24c, which serves to compensate for manufacturing tolerances, in particular on the inner circumference 44 of the sealing element 33 or contact region 38 and/or on the outer circumference of the contact surface 27.

FIGS. 5 and 6 also show that the contact surface 27, which the sealing element 33 abuts in the case of a fluid-tight connection between the screw cap 20 and the material container 30, is located in the region of an end 24d of the inner leg of the receiving groove 24a, which faces away from the material outlet 21. A circumferential stiffening ring 28 extending substantially radially inwardly relative to the fluid reservoir longitudinal axis 12 adjoins the end 24d of the inner leg 24a, which stiffening ring supports the end 24d of the inner leg 24a against a force directed toward the fluid reservoir longitudinal axis 12 and runs substantially parallel to the groove base 24c of the receiving groove 22. The stiffening ring 28 extends in the radial direction to the fluid reservoir longitudinal axis 12 between 3 mm and 7 mm, in particular between 4 mm and 5 mm from the end 24d of the inner leg.

The material container 30 has outwardly directed fastening means 45 in the upper rim region 32, in particular in the form of a material container external thread 45, and the screw cap 20 has inwardly directed counter-fastening means 29, in particular in the form of a screw cap internal thread 29. The sealing element 33, the material container 30 and the material container external thread 45 as well as the screw cap 20 and the screw cap internal thread 29 are in each case designed as one-piece injection-molded parts.

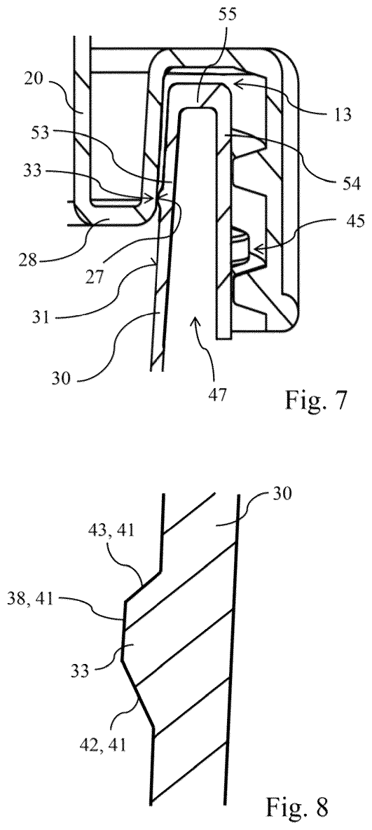

FIG. 7 shows an alternative embodiment of the upper rim region 32 of the material container 30, in which the material container 30 is formed by a foldback in this region which encloses a material recess 47 between the part of the foldback bearing the material container external thread 45 and the material container inner surface 31 bearing the sealing element 33. The foldback helps to save material during production by means of plastic injection molding, the material container 30 being made more elastic in this region for better sealing toward the screw cap and material accumulation is avoided, which leads to fewer manufacturing tolerances.

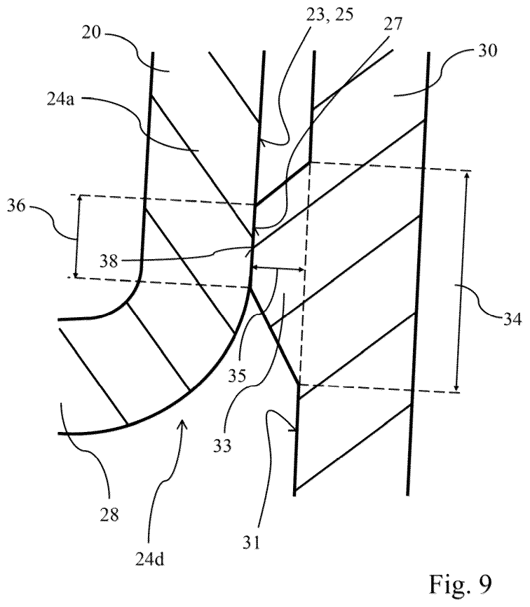

FIG. 8 shows the sealing element of FIG. 7 in detail, wherein the sealing element 33 of the other previously described figures is designed in the same way. The only differences are the presence of the material recess 47. The sealing element outer surface 41 has a contact region 38, a sealing element upper flank 43 connected to the contact region 38 in the direction of the material outlet 21 and a sealing element lower flank 42 connected to the contact region 38 in the opposite direction.

FIG. 9 shows the sealing situation between screw cap 20 and material container 30 in detail. The sealing element 33 running around the material container inner surface 31 has a sealing element width 34 which runs in the direction of the fluid reservoir longitudinal axis 12, shown for example in FIG. 2, and along the material container inner surface 31. The sealing element further has a sealing element height 35 in which the sealing element 33 projects from the material container inner surface 31 in the radial direction to the fluid reservoir longitudinal axis 12. The sealing element width 34 is greater than the sealing element height 35. The sealing element width 34 is in particular at least ⅓ larger than the sealing element height. In a further embodiment, the sealing element width 34 can be twice the sealing element height 35 or more.

FIG. 9 further shows that the sealing element 33 has a contact region 38, at which the sealing element 33 abuts the sealing surface of the screw cap 20 and the width 36 of the contact region 38 in the direction of the fluid reservoir longitudinal axis 12 is greater than the sealing element height 35. In the present case, the width 36 of the contact region is 1.5 times the sealing element height 35, wherein the width 36 of the contact region can also be twice or three times the sealing element height 35.

In the embodiment shown here, the sealing element 33 has a contact region 38 where the sealing element 33 abuts the screw cap 20, which is designed to be so flat that the width 36 of the contact region 38 in the direction of the fluid reservoir longitudinal axis 12, in which the sealing element 33 is brought into contact with the sealing surface 23 when the material container 30 and screw cap 20 are connected in a fluid-tight manner, is greater than ⅓ of the sealing element width 34, but is smaller than the sealing element width 34, in the direction of the fluid reservoir longitudinal axis 12.

Alternatively, the sealing element can also be designed such that the width 36 of the contact region 38 is half or ⅔ of the sealing element width 34.

As can be seen in FIG. 9, the sealing element 33 has a substantially trapezoidal cross-section, which in the case shown is a non-isosceles trapezoid, the leg of which shown in FIG. 8 and referred to as the sealing element upper flank 43 is shorter than the leg referred to as the sealing element lower flank 42.

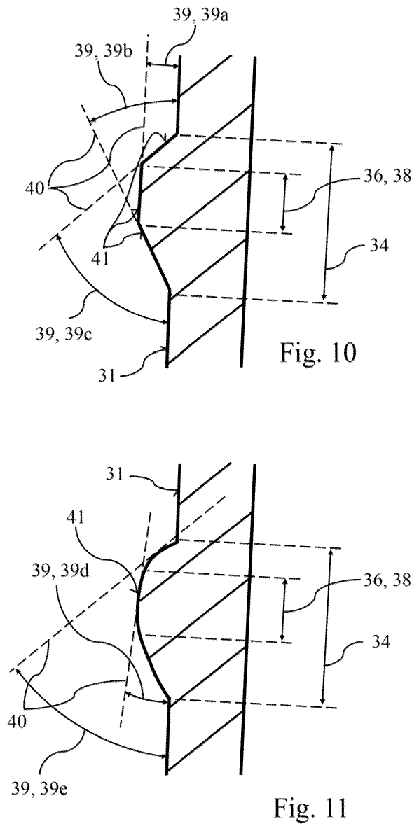

FIGS. 10 and 11 show, by way of example, two different embodiments of a sealing element according to the invention. The different designs have in common that the contact region 38 is designed so flat that the sealing element 33 is brought into planar contact with the sealing surface 23 of the screw cap 20. Obviously, further embodiments are possible which fall within the scope of protection due to the wording of the patent claims.

FIGS. 10 and 11 illustrate that certain geometries can be derived, which, when taken into account, can result in the creation of a sealing element 33 having the advantages described above. As can be seen, such sealing elements 33 can have both a flat contact region 38 and a curved contact region 38. Likewise, the sealing element lower flank 42 and/or the sealing element upper flank 43 can be curved, as shown in FIG. 11. In both cases, the contact region 38 abuts the sealing surface 23 of the screw cap 20 (not shown herein) or abuts the contact surface 27 of the sealing surface 23, whereby the improvements described above can be achieved. As an alternative to the design shown in FIG. 10, roundings can be provided between the contact region 38 and the sealing element lower flank 42 and/or the sealing element upper flank 43, by means of which the regions merge into one another.

The figures show that the angle of inclination 39 of the tangent 40 of the sealing element outer surface 41, which faces the fluid reservoir longitudinal axis 12 (not shown herein), is less than 15° across the sealing element width 34 and relative to the material container inner surface 31 in a region of at least ⅓ of the sealing element width 34. Alternatively, the angle of inclination 39 can also be less than 7°. The region in which the corresponding angle of inclination 39 is below said values can also extend over more than half of the sealing element width 34. As can be seen in the figures, in this geometric constellation the acute angle between the material container inner surface 31 and the angle of inclination 39 is to be considered and not the obtuse angle, which must be less than 15° or less than 7°. Both exemplary embodiments meet the aforementioned minimum requirements. In the exemplary embodiment in FIG. 10, the angle of inclination 39 across the width 36 of the contact region 38 is always 0°, since the contact region runs parallel to the material container inner surface 31 in the direction of the fluid reservoir longitudinal axis 12. The width 36 of the contact region 38 is 37% of the sealing element width 34. In the exemplary embodiment in FIG. 11, the region in which the angle of inclination 39 of the tangent 40 of the sealing element outer surface 41 is less than 15° extends over more than half of the sealing element width 34. The values of the angles of inclination 39 are as follows: 39a=0°; 39b=28°; 39c=48°; 39d=7°; 39e=49°.

Both exemplary embodiments show that the sealing element outer surface 41 has a contact region 38, a sealing element upper flank 43 connected to the contact region 38 in the direction of the material outlet 21 and a sealing element lower flank 42 connected to the contact region 38 in the opposite direction, wherein the angle of inclination 39 of the tangent 40 of the sealing element lower flank 42 over its course in the direction of the fluid reservoir longitudinal axis 12 is smaller than the angle of inclination 39 of the sealing element upper flank 43. The transition between the contact region 38 and the sealing element lower flank 42 or sealing element upper flank 43 takes place at the point at which the angle of inclination 39 of the tangent 40 exceeds said value of 15° and 7°, respectively. The fact that the angle of inclination 39 of the sealing element upper flank 43 is greater than the angle of inclination 39 of the sealing element lower flank 42 means that the length of the sealing element lower flank 42 is greater than the length of the sealing element upper flank 43 in the axial direction.

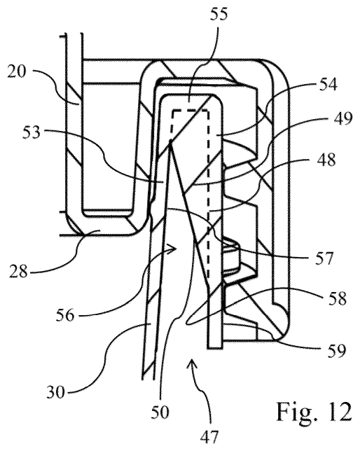

FIG. 12 shows an alternative embodiment of the upper rim region 32 of the material container 30, in which the material container 30 is formed by a foldback 48 in this region, analogous to the embodiment in FIG. 7, which encloses a material recess 47 between the part of the foldback 48 bearing the material container external thread 45 and the material container inner surface 31 bearing the sealing element 33. The foldback 48 runs along the entire upper rim region 32 of the material container 30. The foldback 48 is shown in dashed lines herein, since in this sectional view it is concealed by a stiffening rib 49. The foldback inner leg 53 and the foldback outer leg 54 are connected to one another along their circumference several times by the stiffening ribs 49 which run radially relative to the fluid reservoir longitudinal axis 12. The stiffening ribs 49 extend from the connecting web 55 in the direction of the sealing element 33 on the inner side 57 of the foldback inner leg 53 facing the foldback outer leg 54, wherein the stiffening ribs 49 end in front of the region in which the sealing element 33 is located on the outer side of the foldback inner leg 53 as seen in the radial direction and thus on the material container inner surface 31. On the inner side 58 of the foldback outer leg 54 facing the foldback inner leg 53, the stiffening ribs 49 extend, when viewed in the radial direction, into the region where the material container external thread 45 is provided on the outer side 59 of the foldback outer leg 54. Several stiffening ribs 49 are provided in the upper rim region 32 of the material container 30, which are distributed at equal distances from one another around the circumference. In the example shown, 12 stiffening ribs are provided, wherein advantageously at least 8 and a maximum of 25 stiffening ribs are provided. The stiffening ribs 49 are connected to the foldback inner leg 53 and the foldback outer leg 54 over a different length in the direction of the fluid reservoir longitudinal axis 12. The stiffening ribs bottom side 50 of the stiffening ribs 49, which faces opposite to the screw cap 20, is thus formed obliquely to the radial direction of the fluid reservoir longitudinal axis 12. In the embodiment shown, the stiffening ribs bottom side 50 is inclined to the radial direction such that the angle between the stiffening ribs bottom side 50 and the radial direction is greater than 45°. In fact, the angle is between 60° and 80°.

As can also be seen in FIG. 12, the stiffening ribs 49 are connected over a shorter length to the foldback inner leg 53 than to the foldback outer leg 54 in the direction of the fluid reservoir longitudinal axis 12, thus forming a stiffening rib clearance 56 which extends between the stiffening ribs bottom side 50 and the foldback inner leg 53. The stiffening ribs 49 end at the foldback inner leg 53 in front of the region in which the sealing element 33 is provided. The stiffening rib clearance 56 at the foldback inner leg 53 thus extends into the region in which the sealing element 33 is provided. In the example shown, the stiffening rib clearance 56 ends in a region which, in the direction of the fluid reservoir longitudinal axis 12 and toward the face of the upper rim region 32, is spaced by more than half of the sealing element offset 37 away from the region where the sealing element 33 is provided on the material container inner surface 31.

FIGS. 1 to 12 described above show a fluid reservoir 10, the material container 30 and the screw cap 20 of which are injection-molded and made of polypropylene (PP). This has the advantage that both parts can be made transparent and both parts have the advantageous properties of polypropylene. Especially in case of polypropylene, pairing two identical materials generally leads to unwanted side effects that adversely affect the screwing behavior of the screw connection 11 between the screw cap 20 and the material container 30. For example, a high frictional force is created between the two parts, which must be overcome when mounting and removing the screw cap 20. This is the case, in particular, if the surfaces that rub against one another are very small. This also leads to a kind of stick-slip effect which also negatively affects screwing behavior. Such negative effects can be reduced or prevented by a previously described design of a fluid reservoir 10, wherein at the same time a fluid-tight connection between the screw cap 20 and the material container 30 can be ensured.

The solution described above can also improve the screwing behavior of the screw connection 11 in material pairings other than between two parts made of polypropylene. For example, the screw cap 20 can also be made of high density polyethylene (HDPE) and the material container 30 can be made of polypropylene. With such a combination, the material pairing does not have such a negative effect on screwing behavior as does the material pairing between PP and PP, since HDPE has good sliding properties when paired with other plastics. However, the design of the fluid reservoir 10 as explained above can improve screwing behavior even with this material pairing, while at the same time ensuring a fluid-tight connection between the screw cap 20 and the material container 30.

The fluid reservoir 10 according to the invention and the paint spray gun 1 equipped therewith are suitable for atomizing and applying very different materials. A main area of application is automotive refinishing, where topcoat, filler and clear coat are used and which places very high demands on atomization and the properties of the spray jet. However, a variety of other materials can also be processed using the fluid reservoir 10 and a possibly modified spray gun 1. What is important is that the materials are flowable and, at least to a certain extent, sprayable.

1-19. (canceled)

20. A fluid reservoir for a paint spray gun, the fluid reservoir comprising:
a material outlet configured and dimensioned for direct and/or indirect connection to a paint spray gun,
a material container with a screw cap which closes the material container and has a fluid reservoir longitudinal axis,
wherein, when the material container and screw cap are connected in a releasable and fluid-tight manner thereby forming a screw connection, an upper rim region of the material container is receivable in a receiving groove on the screw cap,
wherein the upper rim region of the material container has a projecting circumferential sealing element which is brought into planar sealing contact with a sealing surface of the screw cap.

21. The fluid reservoir according to claim 20, wherein the sealing element projects from a material container inner surface and is brought into planar sealing contact with an outwardly facing sealing surface of the screw cap.

22. The fluid reservoir according to claim 21, wherein the circumferential sealing element has a sealing element width, which runs in the direction of the fluid reservoir longitudinal axis and along the material container inner surface, and a sealing element height in which the sealing element projects from the material container inner surface in the radial direction to the fluid reservoir longitudinal axis, and wherein the sealing element width is greater than the sealing element height.

23. The fluid reservoir according to claim 22, wherein the sealing element has a contact region at which the sealing element abuts the sealing surface of the screw cap and the width of the contact region in the direction of the fluid reservoir longitudinal axis is at least ⅔ of the sealing element height.

24. The fluid reservoir according to claim 22, wherein the sealing element has a contact region where the sealing element abuts the screw cap, which is designed to be flat so that the width of the contact region in the direction of the fluid reservoir longitudinal axis, in which the sealing element is brought into contact with the sealing surface when the material container and screw cap are connected in a fluid-tight manner, is greater than ⅓ of the sealing element width in the direction of the fluid reservoir longitudinal axis.

25. The fluid reservoir according to claim 22, wherein an angle of inclination of the tangent of a sealing element outer surface facing the fluid reservoir longitudinal axis is less than 15° over the sealing element width relative to the material container inner surface in a region of at least ⅓ of the sealing element width.

26. The fluid reservoir according to claim 22, wherein the sealing element outer surface has a contact region, a sealing element upper flank connected to the contact region in the direction of the material outlet and a sealing element lower flank connected to the contact region in the opposite direction, wherein the angle of inclination of the tangent of the sealing element lower flank over its course in the direction of the fluid reservoir longitudinal axis is smaller than the angle of inclination of the sealing element upper flank.

27. The fluid reservoir according to claim 20, wherein the material container is formed in the upper rim region by a foldback, the foldback inner leg and the foldback outer leg of which are connected to one another along their circumference several times by stiffening ribs running radially relative to the fluid reservoir longitudinal axis, wherein the stiffening ribs are connected to the foldback inner leg or the foldback outer leg over a different length in the direction of the fluid reservoir longitudinal axis.

28. The fluid reservoir according to claim 27, wherein the stiffening ribs are connected over a shorter length to the foldback inner leg than to the foldback outer leg in the direction of the fluid reservoir longitudinal axis, thereby forming a stiffening rib clearance between the foldback inner leg and the stiffening ribs bottom side.

29. The fluid reservoir according to claim 20, wherein the sealing element has a substantially trapezoidal cross-section.

30. The fluid reservoir according to claim 20, wherein on an inner side relative to the fluid reservoir longitudinal axis, the receiving groove on the screw cap is formed by an inner leg extending opposite the material outlet and in the direction of the fluid reservoir longitudinal axis, on the inner leg outer side facing opposite to the fluid reservoir longitudinal axis of which the sealing surface is provided, wherein the sealing element is offset from the front face of the upper rim region of the material container in the form of a sealing element offset over at least half of the inner leg length with which the inner leg extends in the direction of the fluid reservoir longitudinal axis.

31. The fluid reservoir according to claim 30, wherein the material container inner surface and the inner leg outer side have a flat guide region running in the direction of the fluid reservoir longitudinal axis, which extends from the sealing element or a contact surface of the sealing element on the screw cap in the direction of the fluid reservoir longitudinal axis and toward the material outlet, at least over the length in which the sealing element is offset from the front face of the upper rim region of the material container.

32. The fluid reservoir according to claim 30, wherein, when the material container and screw cap are connected in a fluid-tight manner, the inner circumference of the sealing element in the contact region and the outer circumference of the sealing surface in the region of the contact surface are designed such that the front face of the upper rim region and the groove base of the receiving groove are spaced apart from one another in the direction of the fluid reservoir longitudinal axis in such a way that a clearance is formed between the front face of the upper rim region and the groove base, which clearance in particular compensates for manufacturing tolerances.

33. The fluid reservoir according to claim 30, wherein the contact surface, which the sealing element abuts with a fluid-tight connection between the screw cap and the material container, is located in the region of an end of the inner leg of the receiving groove, which faces away from the material outlet.

34. The fluid reservoir according to claim 30, wherein a circumferential stiffening ring extending substantially radially inwardly relative to the fluid reservoir longitudinal axis adjoins the end of the inner leg, which stiffening ring supports the end of the inner leg against a force directed toward the fluid reservoir longitudinal axis.

35. The fluid reservoir according to claim 20, wherein the material container has an outwardly directed material container external thread in the upper rim region and the screw cap has an inwardly directed screw cap internal thread.

36. The fluid reservoir according to claim 20, wherein the sealing element, the material container, and the material container external thread as well as the screw cap and the screw cap internal thread are in each case designed as a one-piece injection-molded part.

37. The fluid reservoir according to claim 20, wherein the material container and the screw cap are injection-molded from polypropylene, or the material container is injection-molded from polypropylene and the screw cap is injection-molded from high-density polyethylene.

38. A screw cap or material container of the fluid reservoir according to claim 20.
